(19) United States
(12) Patent Application Publication
(10) Pub. No.: US 2017/0022915 A1
(43) Pub. Date: Jan. 26, 2017

(54) CYLINDER DEACTIVATION APPARATUS OF ENGINE AND CONTROL METHOD THEREOF

(71) Applicant: HYUNDAI MOTOR COMPANY, Seoul (KR)

(72) Inventor: Hyoung Hyoun KIM, Hwaseong-si (KR)

(73) Assignee: HYUNDAI MOTOR COMPANY, Seoul (KR)

(21) Appl. No.: 14/955,999

(22) Filed: Dec. 1, 2015

(30) Foreign Application Priority Data
Jul. 20, 2015 (KR) 10-2015-0102663

(51) Int. Cl. F02D 41/00; F01N 13/10; F02M 35/104

(52) U.S. Cl. CPC F02D 41/0087; F02M 35/104; F01N 13/10

(57) ABSTRACT

A cylinder deactivation apparatus of an engine selectively deactivates at least one of a plurality of cylinders. The cylinder deactivation apparatus may include a deactivation intake port disposed to supply intake air to a cylinder which is selectively deactivated. A deactivation intake valve is disposed at the deactivation intake port so as to selectively open/close the deactivation intake port. A deactivation exhaust port is disposed to exhaust exhaust gas from the cylinder which is selectively deactivated. A deactivation intake valve is disposed at the deactivation exhaust port so as to selectively open/close the deactivation exhaust port, and a controller controls operation of the deactivation intake valve and the deactivation intake valve.

### CROSS-REFERENCE TO RELATED APPLICATIONS

This application claims the benefit of Korean Patent Application No. 10-2015-0102663 filed on Jul. 20, 2015, the contents of which are incorporated herein by reference in its entirety.

### FIELD

The present disclosure relates to a cylinder deactivation apparatus of an engine.

### BACKGROUND

The statements in this section merely provide background information related to the present disclosure and may not constitute prior art.

In general, an internal combustion engine is an apparatus that operates using energy from heat generated by burning a gas mixture in a combustion chamber. As an internal combustion engine, a multi-cylinder engine with a plurality of cylinders for increasing power and reducing noise and vibration is generally used.

Recently, a cylinder deactivation apparatus of an engine that improves fuel efficiency by deactivating some of a plurality of cylinders in an engine when the engine generates a small amount of power has been developed with the increase in energy cost.

A way of deactivating cylinders used by such a cylinder deactivation apparatus is to operate an engine by injecting and burning a gas mixture in only some of the plurality of cylinders without injecting and igniting a gas mixture in the other cylinders.

For example, for a four-cylinder engine, the apparatus does not inject and ignite a gas mixture in two cylinders and operates the engine with only the other two cylinders.

However, according to the cylinder deactivation apparatus of the related art, there is a need for a variable valve lift technique to appropriately adjust valve lift, so the manufacturing cost of the cylinder deactivation apparatus increases. Further, when the valve lift is controlled hydraulically or electronically, the structure of an engine may be complicated and durability may be difficult to maintain. Meanwhile, operational reliability may be deteriorated in control of the valve lift. Further, direct control of an intake valve may be a concern in terms of reducing noise and shock.

### SUMMARY

The present disclosure provides a cylinder deactivation apparatus of an engine and a control method thereof having advantages of improving operational reliability.

The present disclosure provides a cylinder deactivation apparatus of an engine and a control method thereof having further advantages of having high durability and reducing manufacturing cost by having a simple configuration.

A cylinder deactivation apparatus of an engine according to one form of the present disclosure may be a cylinder deactivation apparatus of an engine that selectively deactivates at least one of a plurality of cylinders. The cylinder deactivation apparatus may include: a deactivation intake port disposed to supply intake air to a cylinder which is selectively deactivated; a deactivation intake valve disposed at the deactivation intake port so as to selectively open/close the deactivation intake port; a deactivation exhaust port disposed to exhaust exhaust gas from the cylinder which is selectively deactivated; a deactivation intake valve disposed at the deactivation exhaust port so as to selectively open/close the deactivation exhaust port; and a controller controlling operation of the deactivation intake valve and the deactivation intake valve.

The deactivation intake valve and the deactivation intake valve may be controlled such that the opening amount of the deactivation intake port and the deactivation exhaust port are to be in synchronization with each other.

The deactivation intake valve may be provided to a chamber which is disposed at the deactivation intake port, and may be configured to include: a plate portion formed in a flat plate shape so as to selectively open/close the deactivation intake port; and a hinge member which is a pivot shaft of the plate portion.

The deactivation exhaust valve may be provided to a chamber which is disposed at the deactivation exhaust port, and may be configured to include: a plate portion formed in a flat plate shape so as to selectively open/close the deactivation exhaust port; and a hinge member which is a pivot shaft of the plate portion.

The cylinders which are selectively deactivated may be at least two cylinders, and the deactivation intake port may be diverged so as to be communicate to the at least two cylinder which are selectively deactivated.

The cylinders which are selectively deactivated may be at least two cylinders, and the deactivation exhaust port may be diverged so as to be communicate to the at least two cylinder which are selectively deactivated.

The deactivation intake valve may be operated to duty-control the opening amount of the deactivation intake port.

The deactivation exhaust valve may be operated to duty-control the opening amount of the deactivation exhaust port.

A control method of a cylinder deactivation apparatus of an engine according to one form of the present disclosure may include: recognizing operation states of an engine; controlling a deactivation intake valve; and controlling a deactivation exhaust valve.

The step of recognizing operation states of an engine may include determining whether the engine start is ON/OFF.

The step of recognizing operation states of an engine may include determining whether deactivation of a deactivation cylinder is required.

The deactivation intake valve may be controlled to close a deactivation intake port when the deactivation of the deactivation cylinder is required.

The deactivation exhaust valve may be controlled to be in synchronization with the deactivation intake valve so as to close the deactivation exhaust port.

The opening amount that the deactivation intake valve opens a deactivation intake port may be duty-controlled depending on operation states of an engine when the deactivation of the deactivation cylinder is not required.

The opening amount that the deactivation exhaust valve opens a deactivation exhaust port may be duty-controlled depending on the opening amount that is the deactivation intake valve opens the deactivation intake port.

The deactivation intake valve and the deactivation exhaust valve may be controlled to be in synchronization with each other.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a diagram illustrating the configuration of a cylinder deactivation apparatus of an engine according to one form of the present disclosure, in which cylinders have been deactivated;

FIG. 2 is a diagram illustrating the configuration of the cylinder deactivation apparatus of an engine according to one form of the present disclosure, in which cylinders have not been deactivated;

FIG. 3 is a diagram illustrating the configuration of a cylinder deactivation apparatus of an engine according to one form of the present disclosure, in which cylinders have been duty-controlled;

FIG. 4 is a schematic diagram of a control method of a cylinder deactivation apparatus of an engine according to one form of the present disclosure; and

FIG. 5 is a flowchart of a control method of a cylinder deactivation apparatus of an engine according to one form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

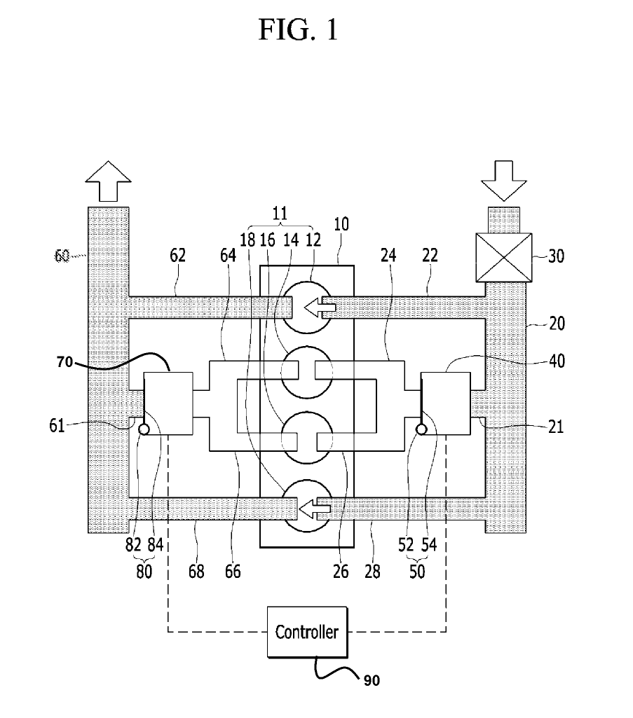

FIG. 1 is a diagram illustrating the configuration of a cylinder deactivation apparatus of an engine according to one form of the present disclosure, in which cylinders have been deactivated.

As shown in FIG. 1, a cylinder deactivation apparatus of an engine according to one form of the present disclosure includes a deactivation intake port 21, a deactivation intake chamber 40, a deactivation intake valve 50, a deactivation exhaust port 61, a deactivation exhaust chamber 70, a deactivation exhaust valve 80, and a controller 90.

The deactivation intake port 21 is adapted that one end thereof is communicated with an intake manifold 20 which is a passage for guiding a gas mixture or air to each cylinder 11 of an engine. An air throttle valve 30 which adjusts the amount of air flowing into the intake manifold 20 in accordance with the degree of operation of an accelerator pedal is mounted in the intake manifold 20. The air throttle valve 30 is well known to a person of ordinary skill in the art, so the detailed description thereof will be omitted. In FIG. 1 to FIG. 3, flow of air being flowed into the intake manifold 20 and being supplied to the cylinders 11 is indicated by arrows.

Although the cylinder deactivation apparatus is applied for a four-cylinder engine with four cylinders 11 in a cylinder block 10 in FIG. 1, the cylinder deactivation apparatus of an engine according to one form of the present disclosure is not limited thereto.

For the convenience, the cylinder deactivation apparatus is applied to a four-cylinder engine in the following description, in which four cylinders 11 will be called, in order of arrangement, “first cylinder 12, second cylinder 14, third cylinder 16, and fourth cylinder 18.” In addition, the intake ports which are diverged from the intake manifold 20 so as to be respectively communicated with the first cylinder 12, the second cylinder 14, the third cylinder 16, and the fourth cylinder 18 will be called “first intake port 22, second intake port 24, third intake port 26, and fourth intake port 28”.

The second intake port 24 and the third intake port 26 are formed to be diverged in two from the other end of the deactivation intake port 21.

The deactivation intake chamber 40 is disposed at the deactivation intake port 21 ahead of the diverging point of the second intake port 24 and the third intake port 26.

The deactivation intake valve 50 is provided to the deactivation intake chamber 40. In addition, the deactivation intake valve 50 is operated to open/close the deactivation intake port 21 or to adjust the amount of intake air flowing into the second intake port 24 and the third intake port 26 from the deactivation intake port 21.

The deactivation intake valve 50 is provided to the deactivation intake chamber 40. In addition, the deactivation intake valve 50 is operated to open/close the deactivation intake port 21 or to adjust the amount of intake air flowing into the second intake port 24 and the third intake port 26 from the deactivation intake port 21.

The deactivation intake valve 50 includes a hinge member 52 and a plate portion 54.

The hinge member 52 is a pivot shaft of the plate portion 54.

The plate portion 54 may be formed in a flat plate shape, and opens/closes the deactivation intake port 21 by pivoting around the hinge member 52. In addition, the amount of intake air flowing into the second intake port 24 and the third intake port 26 from the deactivation intake port 21 is adjusted depending on the degree of opening of the deactivation intake port 21 by the plate portion 54.

The controller 90 is connected with the deactivation throttle chamber 40 so as to control operation of the deactivation intake valve 50 in accordance with operation states of an engine. That is, the controller 90 receives information about the operation states of an engine from various sensors (not shown), and performs control for opening/closing the deactivation intake port 21 in accordance with the information.

The deactivation exhaust port 61 is adapted that one end thereof is communicated with an exhaust manifold 60 which is a passage for receiving exhaust gas form cylinders 11 of an engine so as to exhaust it. In FIG. 1 to FIG. 3, flow of exhaust gas being exhausted from the exhaust manifold 20 is indicated by arrow.

For convenience, the exhaust ports which are diverged from the exhaust manifold 60 so as to be respectively communicated with the first cylinder 12, the second cylinder 14, the third cylinder 16, and the fourth cylinder 18 will be called “first exhaust port 62, second exhaust port 64, third exhaust port 66, and fourth exhaust port 68”.

The second exhaust port 64 and the third exhaust port 66 are formed to be diverged in two from the other end of the deactivation exhaust port 61.

The deactivation exhaust chamber 70 is disposed at the deactivation exhaust port 61.

The deactivation exhaust valve 80 is provided to the deactivation exhaust chamber 70. In addition, the deactivation exhaust valve 80 is operated to open/close the deactivation exhaust port 61 or to adjust an opening and closing amount of the valve depending on the amount of exhaust gas flowing into the deactivation exhaust port 61 from the second exhaust port 64 and third exhaust port 66.

The deactivation exhaust valve 80 includes a hinge member 82 and a plate portion 84.

The hinge member 82 is a pivot shaft of the plate portion 84.

The plate portion 84 may be formed in a flat plate shape, and opens/closes the deactivation exhaust port 61 by pivoting around the hinge member 82. In addition, the amount of exhaust gas flowing into the deactivation exhaust port 61 from the second exhaust port 64 and the third exhaust port 66 is adjusted depending on the degree of opening of the deactivation exhaust port 61 by the plate portion 84.

The controller 90 is connected with the deactivation exhaust chamber 70 so as to control operation of the deactivation exhaust valve 80 in accordance with operation states of an engine. That is, the controller 90 receives information about the operation states of an engine from various sensors (not shown), and performs control for opening/closing the deactivation exhaust port 61 in accordance with the information.

Meanwhile, the deactivation intake valve 50 and the deactivation exhaust valve 80 are controlled to be in synchronization with each other by the controller 90. That is, the operation of the deactivation exhaust valve 80 is controlled depending on the operation of the deactivation intake valve 50 such that the amount of opening/closing the deactivation exhaust port 61 may be controlled to be equal to the amount of opening/closing the deactivation intake port 21.

Hereinafter, the operation of a cylinder deactivation apparatus of an engine according to one form of the present disclosure will be described referring to FIG. 1 to FIG. 3. In FIG. 1 to FIG. 3, the amount of intake air passing through the air throttle valve 30 and then flowing via the intake manifold 20, the first intake port 22, the second intake port 24, the third intake port 26, the fourth intake port 28, the first exhaust port 62, the second exhaust port 64, the third exhaust port 66, the fourth exhaust port 68, and the exhaust manifold 60 is indicated by shading in FIGS. 1 to 3.

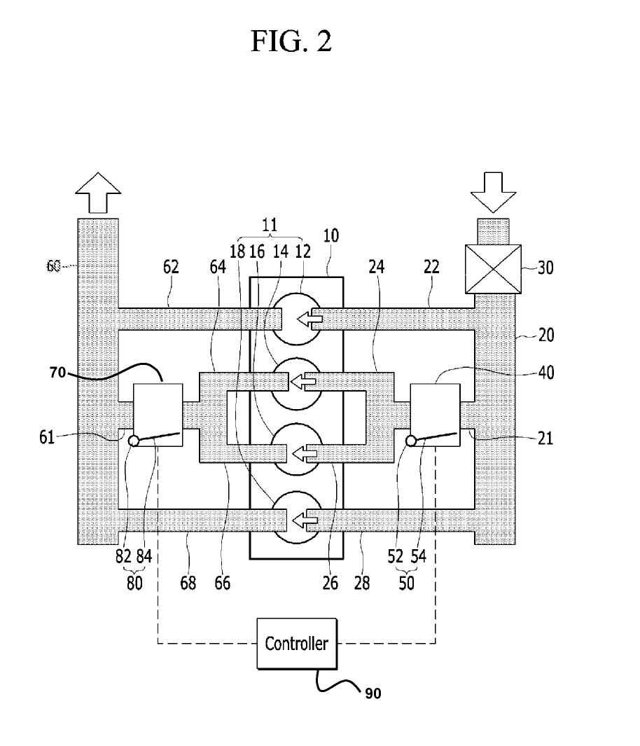

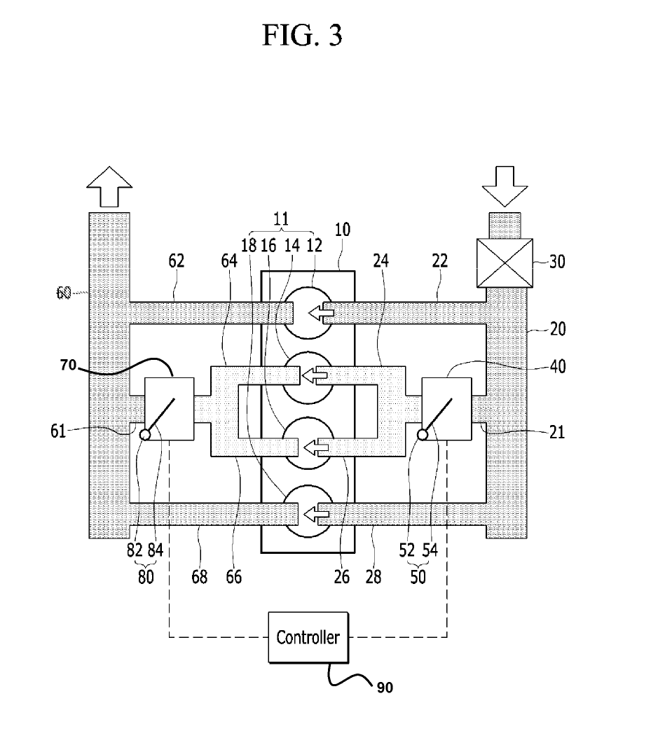

FIG. 2 is a diagram illustrating the configuration of the cylinder deactivation apparatus of an engine according to an exemplary embodiment of the present disclosure, in which cylinders have not been deactivated, and FIG. 3 is a diagram illustrating the configuration of a cylinder deactivation apparatus of an engine according to an exemplary embodiment of the present disclosure, in which cylinders have been duty-controlled.

As shown in FIG. 1, with the deactivation intake port 21 closed, intake air is not supplied to the second intake port 24 and the third intake port 26. That is, intake air is not supplied to the second cylinder 14 and the third cylinder 16. At this time, the deactivation exhaust valve 80 is to be in synchronization with the operation of the deactivation intake valve 50 closing the deactivation intake port 21 so as to close the deactivation exhaust port 61. That is, the second cylinder 14 and the third cylinder 16 are deactivated.

As shown in FIG. 2, with the deactivation intake port 21 open, intake air is supplied to the second intake port 24 and the third intake port 26, to the same as the first intake port 22 and the fourth intake port 28. At this time, the deactivation exhaust valve 80 is to be in synchronization with the operation of the deactivation intake valve 50 opening the deactivation intake port 21 so as to open the deactivation exhaust port 61. That is, the second cylinder 14 and the third cylinder 16 are not deactivated.

As shown in FIG. 3, with the opening amount of the deactivation intake port 21 in duty control, the amount of intake air being supplied to the second intake port 24 and the third intake port 26 is duty-controlled. That is, the amount of intake air to be supplied to the second cylinder 14 and the third cylinder 16 is controlled in accordance with the states of an engine. At this time, the deactivation exhaust valve 80 is to be in synchronization with the operation of the deactivation intake valve 50 duty-controlling the opening amount of the deactivation intake port 21 so as to be operated to duty-control the opening amount of the deactivation exhaust port 61. Although static duty control is shown in FIG. 3, the opening amount of the deactivation intake port 21 may be duty-controlled in several steps or continuously by those skilled in the art, if necessary.

In other words, a section realizing effect for improving fuel consumption to be better than the cylinder deactivation may be configured as the opening/closing amount of the deactivation intake port 21 and the deactivation exhaust port 61 can be adjusted between two steps such as ON/OFF in the cylinder deactivation control. An injection amount of fuel may be adjusted according to design so as to improve effectiveness of fuel consumption in the section.

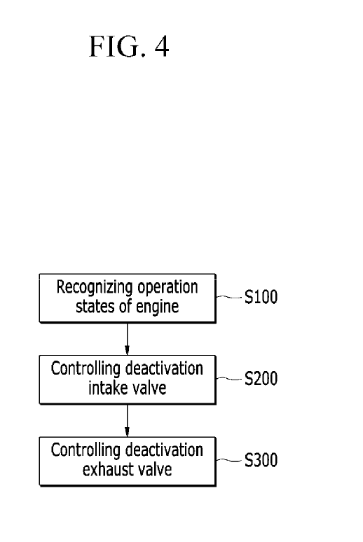

FIG. 4 is a schematic diagram of a control method of a cylinder deactivation apparatus of an engine according to one form of the present disclosure.

As shown in FIG. 4, if an engine is started, the controller 90 recognizes operation states of an engine at a step S100. In addition, the controller 90 controls the deactivation intake valve 50 depending on the recognized operation states of an engine at a step S200. Further, the controller 90 controls the deactivation exhaust valve 80 to be in synchronization with operation states of the deactivation intake valve 50 at a step S300. Herein, the controller 90 may be a general electronic control unit supervising various controls for electronic devices of a vehicle.

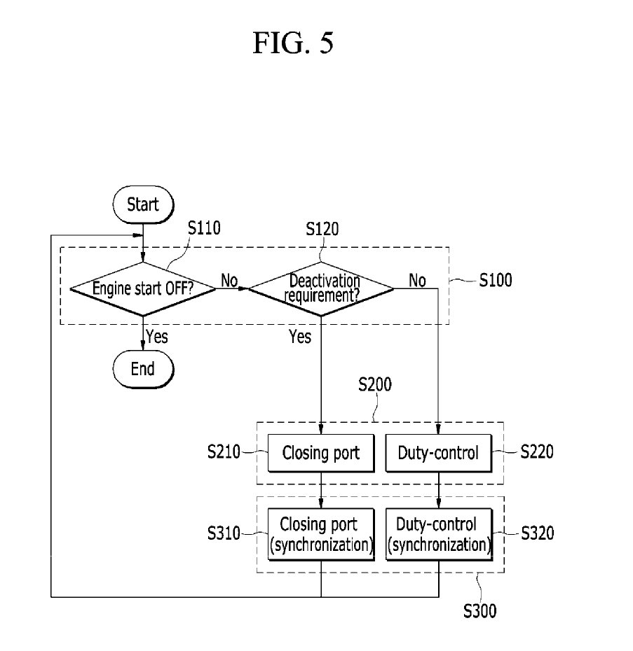

FIG. 5 is a flowchart of a control method of a cylinder deactivation apparatus of an engine according to one form of the present disclosure.

As shown in FIG. 5, in the step S100 of recognizing operation states of an engine, it may be determined whether the engine start is ON/OFF at a step S110. That is, a control method of a cylinder deactivation apparatus of an engine according to one form of the present disclosure is started at the same time with the engine start ON. In addition, in the step S100 of recognizing operation states of an engine, it may be determined whether deactivation of deactivation cylinders 14 and 16 is required at a step S120.

If it is required that the deactivation cylinders 14 and 16 are the deactivated, the deactivation intake valve 50 is controlled to close the deactivation intake port 21 at a step S210 in the step S200 of controlling the deactivation intake valve 50. Thus, in the step S300 of controlling the deactivation exhaust valve 80, the deactivation exhaust valve 80 is controlled to close the deactivation exhaust port 61 at a step S310.

If it is not required that the deactivation cylinders 14 and 16 are deactivated, the opening amount, that the deactivation intake valve 50 opens the deactivation intake port 21, is duty-controlled depending on the recognized operation states of the engine at a step S220 in the step S200 of controlling the deactivation intake valve 50. Thus, in the step S300 of controlling the deactivation exhaust valve 80, the opening amount, that the deactivation exhaust valve 80 opens the deactivation exhaust port 61, is duty-controlled at a step S320.

If the deactivation intake valve 50 and the deactivation exhaust valve 80 are controlled to be in synchronization with each other, the operational reliability can be ensured even while any one of the deactivation intake valve 50 and the deactivation exhaust valve 80 fails. In addition, temperature loss of the deactivation cylinders 14 and 16 may be minimized as the deactivation intake valve 50 and the deactivation exhaust valve 80 simultaneously close the deactivation intake port 21 and the deactivation exhaust port 61.

According to one form of the present disclosure, it may be possible that the amount of intake air is duty-controlled and fuel consumption may be better by applying the deactivation intake valve 50. Further, the cost may be reduced and the operational reliability may be secured as composition becomes simple to control only the deactivation valve 50 and 80. Furthermore, stability a deactivation cylinder can be ensured as an intake part and an exhaust part are controlled to be in synchronization with each other.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A cylinder deactivation apparatus of an engine that selectively deactivates at least one of a plurality of cylinders, the cylinder deactivation apparatus comprising:
a deactivation intake port disposed to supply intake air to a cylinder which is selectively deactivated;
a deactivation intake valve disposed at the deactivation intake port so as to selectively open/close the deactivation intake port;
a deactivation exhaust port disposed to exhaust exhaust gas from the cylinder which is selectively deactivated;
a deactivation intake valve disposed at the deactivation exhaust port so as to selectively open/close the deactivation exhaust port; and
a controller controlling operation of the deactivation intake valve and the deactivation intake valve.

2. The apparatus of claim 1, wherein the deactivation intake valve and the deactivation intake valve are controlled such that the opening amount of the deactivation intake port and the deactivation exhaust port are in synchronization with each other.

3. The apparatus of claim 1, wherein the deactivation intake valve is provided to a chamber which is disposed at the deactivation intake port, and comprises:
a plate portion formed in a flat shape so as to selectively open/close the deactivation intake port; and
a hinge member which is a pivot shaft of the plate portion.

4. The apparatus of claim 1, wherein the deactivation exhaust valve is provided to a chamber which is disposed at the deactivation exhaust port, and is configured to comprise:
a plate portion formed in a flat shape so as to selectively open/close the deactivation exhaust port; and
a hinge member which is a pivot shaft of the plate portion.

5. The apparatus of claim 1, wherein at least two of the cylinders are selectively deactivated, and the deactivation intake port is diverged so as to communicate to the at least two cylinder which are selectively deactivated.

6. The apparatus of claim 1, wherein at least two of the cylinders are selectively deactivated, and the deactivation exhaust port is diverged so as to be communicate to the at least two cylinders which are selectively deactivated.

7. The apparatus of claim 1, wherein the deactivation intake valve is operated to duty-control the opening amount of the deactivation intake port.

8. The apparatus of claim 1, wherein the deactivation exhaust valve is operated to duty-control the opening amount of the deactivation exhaust port.

9. A method for controlling the cylinder deactivation apparatus of an engine according to claim 1 the method comprising:
recognizing operation states of an engine;
controlling a deactivation intake valve; and
controlling a deactivation exhaust valve.

10. The method of claim 9, wherein the step of recognizing operation states of an engine includes determining whether the engine start is ON/OFF.

11. The method of claim 9, wherein the step of recognizing operation states of an engine includes determining whether deactivation of a deactivation cylinder is required.

12. The method of claim 11, wherein the deactivation intake valve is controlled to close a deactivation intake port when the deactivation of the deactivation cylinder is required.

13. The method of claim 12, wherein the deactivation exhaust valve is controlled to be in synchronization with the deactivation intake valve so as to close the deactivation exhaust port.

14. The method of claim 11, wherein the opening amount that the deactivation intake valve opens a deactivation intake port is duty-controlled depending on operation states of an engine when the deactivation of the deactivation cylinder is not required.

15. The method of claim 14, wherein the opening amount that the deactivation exhaust valve opens a deactivation exhaust port is duty-controlled depending on the opening amount that is the deactivation intake valve opens the deactivation intake port.

16. The method of claim 9, wherein the deactivation intake valve and the deactivation exhaust valve are controlled to be in synchronization with each other.
